(19) United States
(12) Patent Application Publication
(10) Pub. No.: US 2008/0231600 A1
(43) Pub. Date: Sep. 25, 2008

(54) Near-Normal Incidence Optical Mouse Illumination System with Prism

(76) Inventor: George E. Smith, Sunnyvale, CA (US)

Correspondence Address: Kathy Manke;Avago Technologies Limited, 4380 Ziegler Road, Fort Collins, CO, 80525, US

(21) Appl. No.: 11/690,526

(22) Filed: Mar. 23, 2007

(51) Int. Cl. G06F 3/033

(52) U.S. Cl. 345/166

(57) ABSTRACT

Disclosed are various embodiments of an optical mouse illumination system that provides near-normal incidence of light beams upon a surface without employing complicated beam-splitter assemblies, and without employing near-grazing incidence methods of illumination. The optical mouse illumination systems disclosed herein provide higher efficiencies than most prior art optical mouse illumination systems, and yet are less expensive and less complicated to manufacture. The systems disclosed herein are also well adapted for use in battery-powered mouse applications. Illumination prisms forming portions of the systems disclosed herein may or may not have total internal reflection (TIR) mirrors incorporated therein. Roof prisms of various types may be employed in conjunction with TIR mirrors and illumination prisms to eliminate or reduce the effect of dark spots in the beam of light emitted by the light source. Coherent or incoherent light sources may be employed with the optical systems described herein.

### FIELD OF THE INVENTION

The present invention relates to the field of optical mice, and more particularly to illumination systems, optical devices, optical components and methods therefor.

### BACKGROUND

The use of a hand operated pointing device for use with a computer and its display has become almost universal. One form of the various types of pointing devices is the conventional (mechanical) mouse, used in conjunction with a cooperating mouse pad. Mechanical mice typically include a rubber-surfaced steel ball that rolls over the mouse pad as the mouse is moved. Interior to the mouse are rollers, or wheels, that contact the ball at its equator and convert its rotation into electrical signals representing orthogonal components of mouse motion. These electrical signals are coupled to a computer, where software responds to the signals to change by a ΔX and a ΔY the displayed position of a pointer (cursor) in accordance with movement of the mouse.

In addition to mechanical types of pointing devices, such as a conventional mechanical mouse, optical pointing devices have also been developed. In one form of optical pointing device, rather than using a moving mechanical element like a ball, relative movement between an imaging surface, such as a finger or a desktop, and an image sensor within the optical pointing device, is optically sensed and converted into movement information.

Electronic image sensors, such as those typically employed in optical pointing devices, are predominantly of two types: charge coupled devices (CCDs) and complimentary metal oxide semiconductor-active pixel sensors (CMOS-APS). Both types of sensors typically contain an array of photodetectors (i.e., pixels), arranged in a pattern. Each individual photodetector operates to output a signal with a magnitude that is proportional to the intensity of light incident on the site of the photodetector. These output signals can then be subsequently processed and manipulated to generate an image that includes a plurality of individual picture elements (pixels), wherein each pixel in the image corresponds with one of the photodetectors (i.e., pixels) in the image sensor.

One form of optical pointing device includes a light source, such as a light emitting diode (LED), for illuminating an imaging or navigation surface to thereby generate reflected images which are sensed by the image sensor of the optical pointing device. Another form of optical pointing device includes a coherent light source, such as a laser, for illuminating an imaging surface to thereby generate reflective images to be sensed by the image sensor of the optical pointing device. Coherent light source based optical navigation with optical pointing devices often provides better imaging surface coverage and superior tracking performance than does a conventional prior art optical pointing device containing an incoherent light source.

Significantly more stringent eye safety regulations apply to coherent light sources such as lasers than to light sources such as LEDs. For example, the International Electro˜Technical Commission (IEC) standard defines Class-1 lasers as lasers that are safe under reasonably foreseeable conditions of operation, including the use of optical instruments for intrabeam viewing. In order to meet the Class-1 classification, no eye damage will occur even if someone looked at the laser for an extensive period of time with a magnifier in front of the laser. The maximum optical power output of a Class-1 laser inside an optical pointing device is limited by the IEC standard based on the wavelength of the laser output and the mode of operation of the laser. For example, a single mode vertical cavity surface emitting laser (VCSEL) having a nominal wavelength of 840 nanometers (nm) is defined by the IEC standard to have a peak optical power output less than 700 microwatts (μW) in a continuous wave (CW) mode to meet the Class-1 classification.

Another form of optical pointing device includes open-loop laser drive circuitry. In one example process for manufacturing an optical pointing device having open-loop laser drive circuitry, the lasers (e.g., VCSELs) are pre-tested to determine the laser threshold current, slope efficiency, and temperature coefficient. The pre-tested lasers are sorted and grouped accordingly into a finite number of bins. Each bin of lasers is matched to a corresponding open-loop current regulating circuit. The corresponding open-loop current regulating circuit can properly adjust the drive current to the corresponding laser to ensure that the laser operates in its defined operating window to provide minimum optical power output and ensure eye safe operation. While this manufacturing process reliably ensures that the proper operating window of the laser is achieved, the manufacturing process is time intensive and costly. In addition, this manufacturing process typically results in a large percentage of the lasers being non-usable due to the limited compensation range provide by the limited number of selectable open-loop current regulating circuits.

Regardless of the type of light source used to provide illumination to an imaging surface by an optical mouse, most optical mice in current use comprise one of four types of optical illumination systems: (1) near-grazing incidence optical illumination systems; (2) near-normal incidence optical illumination systems that employ beam-splitters; (3) horizontal optical illumination systems that employ illumination prisms and total internal reflection (“TIR”) mirrors, and (4) vertical optical illumination systems that employ illumination prisms and total internal reflection.

The first type of near-grazing incidence optical mouse illumination system is illustrated in FIG. 1. Optical mouse illumination system 10 comprises light source 15, which is preferably a light emitting diode (LED) or laser that emits a first direct beam of light 20 in a first direction 25 (not shown). A collimating lens 35 (also not shown in FIG. 1) gathers and directs first light beam 20 to form second light beam 85 travelling in second direction 90 (which may or may not be substantially the same direction as first direction 25, depending on whether system 10 utilizes reflecting or refracting members to re-direct first beam 20 in a different direction). Second beam 85 is incident upon surface 100, and portions thereof are reflected to form beam 125 travelling in direction 145. Other portions of incident beam 85 are scattered by imperfections and irregularities in surface 100 to form third scattered or reflected light beam 105. Imaging lens 130 collects and directs third light beam 105 upwardly towards sensor 140, which detects and measures the amount of light incident thereon.

As shown in FIG. 1, a relatively large proportion of the light generated by light source 15 in system 10 never reaches sensor 140, and instead is reflected from surface 100 as unusable energy. Moreover, system 10 illustrated in FIG. 1 has a limited depth of focus, generally requires the use of high-efficiency LEDS and a correspondingly high electrical current provided thereto, and features a relatively broad illuminated object area 150. In addition, system 10 of FIG. 1 has an overall efficiency ranging between about 1 and 4 percent, making it less suitable for increasingly-popular battery-powered mouse applications where power consumption must be minimized.

The second type of beam-splitting, near-normal-incidence optical mouse illumination system is illustrated in FIG. 2. Optical mouse illumination system 10 comprises light source 15, which again is preferably a light emitting diode (LED) or laser that emits a first direct beam of light 20 in a first direction 25. A collimating lens 35 gathers and directs first light beam 20 to form second light beam 85 travelling in second direction 90 after having been reflected from first reflecting face 50a of prism 65. Second bean 85 is incident upon second reflecting face 50b, and is reflected therefrom downwardly towards surface 100 for reflection up towards second reflecting face 50b of beam splitter 45, and thence through beam splitter 45 as third light beam 105 for collection by imaging lens 130. Aperture stop 135 prevents unwanted light from impinging on sensor 140. As shown in FIG. 2, illuminated object area 150 is advantageously relatively small and constrained in areal extent.

System 10 illustrated in FIG. 2 provides near-normal incidence of light beams in respect of surface 100, and therefore has a greater depth of focus, and provides improved scattering of light in respect of system 10 illustrated in FIG. 1. Unfortunately, however, system 10 illustrated in FIG. 2 suffers from several drawbacks. Chief among these is the maximum theoretical efficiency of the beam-splitting system illustrated in FIG. 2, which is only 25% due to beam splitter 45 halving signal power at each interface. In practice, the actual efficiency of system 10 in FIG. 2 is less than 10%. Consequently, system 10 of FIG. 2 consumes an excessive amount of power, making it less than optimal for battery-powered mouse applications. Additionally, the complex shapes, expensive components, and overall configuration of system 10 in FIG. 2 are difficult and expensive to manufacture. The various optical components in such a system must be very precisely aligned and assembled respecting one another, with little tolerance for error. Further details concerning one embodiment of a prior art beam-splitting optical illumination system may be found in U.S. Patent Publication No. 2006/0176581 entitled “Light Apparatus of an Optical Mouse with an Aperture Stop and the Light Protection Method Thereof” to Lu.

FIG. 3 shows a prior art horizontal optical illumination system 10 employed commercially in certain APPLE™ mouse products comprising illumination prism 65 and TIR mirror 55. Light source 15 is an LED and emits a first direct beam of light 20 in a first direction 25. Collimating lens 35 gathers first light beam 20 and directs same through input face 70 of illumination prism 65 for reflection from first reflecting face 50a of TIR mirror 55 to form second light beam 85 travelling in second direction 90.

Second beam 85 becomes incident upon second reflecting face 50b (which may also be a TIR mirror), and is reflected therefrom for passage through refracting output face 75 of prism 65 as third beam 105, which then becomes incident on surface 100. Third beam 105 is next reflected upwardly from surface 100 in direction 145 to form fourth beam 125, which is collected by imaging lens 130 (not shown). As illustrated in FIG. 3, illumination object area 150 comprises a relatively large surface area that typically ranges between about 3 mm and about 5 mm in length (i.e., along the page) and between about 2 mm and about 3 mm in width (i.e., into the page), or between about 6 mm² and about 15 mm² in surface area.

Note that in prior art system 10 illustrated in FIG. 3, vertically-folded roof prism 84 may be attached to or form a portion of prism 85 such that refracting output face 75 forms a portion of vertically folded roof prism 84. Illumination prism 65 is configured in respect of light source 15, collimating lens 15 and first light beam 20 such that beam 20 hits first reflecting face 50a at an angle greater than or equal to the critical angle, more about which I say below.

FIG. 4 shows a prior art vertical optical illumination system 10 employed commercially in certain APPLE™ mouse products comprising illumination prism 65 and TIR mirror 55. Light source 15 is an LED that emits a first direct beam of light 20 in a first direction 25. Collimating lens 35 gathers first light beam 20 and directs same through input face 70 of illumination prism 65 for reflection from first reflecting face 50a of total internal reflection (“TIR”) mirror 55 to form second light beam 85 travelling in second direction 90. As shown in FIG. 4, first reflecting face 50a may comprise TIR mirror 55 and four-faceted-face folded roof prism 80. Second beam 85 is incident upon second reflecting face 50b, and is reflected therefrom for passage through refracting output face 75 of prism 65 as third beam 105, which then becomes incident on surface 100. Third beam 105 is next reflected upwardly from surface 100 in direction 145 to form fourth beam 125, which is collected by imaging lens 130 (not shown).

As illustrated in FIG. 4, illumination object area 150 comprises a relatively large surface area that typically ranges between about 3 mm and about 5 mm in length (i.e., along the page) and between about 2 mm and about 3 mm in width (i.e., info the page), or between about 6 mm² and about 15 mm² in surface area. Illumination prism 65 is configured in respect of laser 15, collimating lens 35 and first light beam 20 such that beam 20 hits first reflecting face 50a at an angle greater than or equal to the critical angle, and does so with virtually no losses.

Prior art systems 10 of FIGS. 1, 3 and 4 suffer from the substantial problems introduced by relatively low angles of incidence b, which typically range between about 50 degrees and about 80 degrees in respect of a normal to surface 100. Among other things, such non-normal or non-near-normal incidence causes the depth of field of system 10 to be undesirably relatively small, and illumination area 150 to be undesirably large. While prior art system 10 of FIG. 2 provides desirable near-normal incidence of light beams on surface 100, good depth of field and a relatively small illumination area 150, such a system has low optical efficiency (less than 10% in practice), is optically elaborate and relatively expensive to manufacture.

What is needed is an optical mouse illumination system that may be employed in laser and non-laser applications, consumes less power than currently-available systems, has improved depth of field, is relatively inexpensive and uncomplicated to manufacture, and is mechanically robust and reliable.

Various patents containing subject matter relating directly or indirectly to the field of the present invention include, but are not limited to, the following:

U.S. Pat. No. 4,553,842 to Griffin for “Two dimensional optical position indicating apparatus,” Nov. 19, 1985.

U.S. Pat. No. 4,751,505 to Williams et al., for “Optical mouse,” Jun. 14, 1988.

U.S. Pat. No. 5,463,387 to Kato for “Optical mouse and resin lens unit,” Oct. 31, 1995.

U.S. Pat. No. 5,578,813 to Allen et al., for “Freehand image scanning device which compensates for non-linear movement,” Nov. 26, 1996.

U.S. Pat. No. 5,644,139 to Allen et al., for “Navigation Technique for Detecting Movement of Navigation Sensors Relative to an Object,” Jul. 1, 1997.

U.S. Pat. No. 5,703,356 to Bidiville et al., for “Pointing device utilizing a photodetector array,” Dec. 30, 1997.

U.S. Pat. No. 5,788,804 to Gordon for “Method and system for tracking attitude,” Jul. 28, 1998.

U.S. Pat. No. 5,994,710 to Knee et at, for “Scanning mouse for a computer system,” Nov. 30, 1999.

U.S. Pat. No. 6,111,563 to Hines for “Cordless retroreflective optical computer mouse,” Aug. 29, 2000.

U.S. Pat. No. 6,218,730 to Toy et al. for “Apparatus for controlling thermal interface gap distance,” Apr. 17, 2001.

U.S. Pat. No. 6,281,882 to Gordon for “Proximity detector for a seeing eye mouse,” Aug. 28, 2001.

U.S. Pat. No. 6,294,408 to Edwards et al. for “Method for controlling thermal interface gap distance,” Sep. 25, 2001.

U.S. Pat. No. 6,429,511 to Ruby et al. for “Microcap wafer-level package,” Aug. 6, 2002.

U.S. Pat. No. 6,433,780 to Gordon et al., for “Seeing eye mouse for a computer system,” Aug. 13, 2002.

U.S. Pat. No. 6,442,725 to Schipke et al. for “System and method for intelligent analysis probe,” Aug. 27, 2002.

U.S. Pat. No. 6,476,970 to Smith for Illumination optics and method,” Nov. 5, 2002.

U.S. Pat. No. 6,501,460 to Paik et al., for “Light-receiving unit for optical mouse and optical mouse having the same,” Dec. 31, 2002.

U.S. Pat. No. 6,613,498 to Brown et al. for “Modulated exposure mask and method of using a modulated exposure mask,” Sep. 2, 2003.

U.S. Pat. No. 6,717,735 to Smith for “Lens structures for flux redistribution and for optical low pass filtering,” Apr. 6, 2004.

U.S. Pat. No. 6,784,535 to Chiu for “Composite lid for land grid array (LGA) flip-chip package assembly,” Aug. 31, 2004.

U.S. Pat. No. 6,829,098 to Smith for “Illumination optics and method,” Dec. 7, 2004.

U.S. Pat. No. 6,849,941 to Hill et al. for “Heat sink and heat spreader assembly,” Feb. 1, 2005.

U.S. Pat. No. 6,860,652 to Narayan et al. for “Package for housing an optoelectronic assembly,” Mar. 1, 2005.

U.S. Pat. No. 6,867,368 to Kumar et al. for “Multi-layer ceramic feedthrough structure in a transmitter optical subassembly,” Mar. 15, 2005.

U.S. Pat. No. 6,900,509 to Gallup et al. for “Optical receiver package,” May 31, 2005.

U.S. Pat. No. 6,905,618 to Matthew et al. for “Diffractive optical elements and methods of making the same,” Jun. 14, 2005.

U.S. Pat. No. 6,919,222 to Geefay for “Method for sealing a semiconductor device and apparatus embodying the method,” Jul. 19, 2005.

U.S. Pat. No. 6,932,522 to Zhou for “Method and apparatus for hermetically sealing photonic devices,” Aug. 23, 2005.

U.S. Pat. No. 6,934,037 to DePue et al. for “System and method for optical navigation using a projected fringe technique,” Aug. 23, 2005.

U.S. Pat. No. 6,938,919 to Chuang et al. for “Heatsink-substrate-spacer structure for an integrated-circuit package,” Aug. 30, 2005.

U.S. Pat. No. 6,947,224 to Wang for “Methods to make diffractive optical elements,” Sep. 20, 2005.

U.S. Pat. No. 6,998,304 to Aronson et al. for “Small form factor transceiver with externally modulated laser,” Feb. 7, 2006.

U.S. Pat. No. 6,998,691 to Baugh et al. for “Optoelectronic device packaging with hermetically sealed cavity and integrated optical element,” Feb. 14, 2006.

U.S. Pat. No. 7,042,575 to Carlisle et al., for “Speckle sizing and sensor dimensions in optical positioning device,” May 9, 2006.

U.S. Pat. No. 7,050,043 to Huang et al., for “Optical apparatus,” May 23, 2006.

U.S. Pat. No. 7,066,660 to Ellison for “Optoelectronic packaging assembly,” Jun. 27, 2006.

U.S. Pat. No. 7,091,601 to Philliber for “Method of fabricating an apparatus including a sealed cavity,” Aug. 15, 2006.

U.S. Pat. No. 7,116,427 to Baney et al., for “Low power consumption, broad navigability optical mouse,” Oct. 3, 2006.

U.S. Pat. No. 7,126,585 to Davis et al., for “One chip USB optical mouse sensor solution,” Oct. 24, 2006.

U.S. Pat. No. 7,131,751 to Theytaz et al. for “Attachment system for use in an optical illumination system,” Nov. 7, 2006.

U.S. Pat. No. 7,161,682 to Xie et al. for “Method and device for optical navigation,” Jan. 9, 2007.

U.S. Pat. No. 7,166,831 to DePue et al. for “Optical mouse with replaceable contaminant barrier,” Jan. 23, 2007.

U.S. Pat. No. 7,184,022 to Xie et al. for “Position determination and motion tracking,” Feb. 27, 2007.

U.S. Patent Publication No. 2003/0034959 to Davis et al. entitled “One-Chip USB Optical Mouse Sensor Solution,” Feb. 20, 2003.

U.S. Patent Publication No. 2003/0118825 to Geefay et al. entitled “Wafer-level package with silicon gasket,” Jun. 26, 2003.

U.S. Patent Publication No. 2003/0197254 to Huang entitled “Package for enclosing a laser diode module,” Oct. 23, 2003.

U.S. Patent Publication No. 2003/0223709 to Lake et al. entitled “Methods of sealing electronic, optical and electro-optical packages and related package and substrate designs,” Dec. 4, 2003.

U.S. Patent Publication No, 2004/0086011 to Bhandarkar entitled “Planar and wafer level packaging of semiconductor lasers and photo detectors for transmitter optical sub-assemblies,” May 6, 2004.

U.S. Patent Publication No. 2004/0084610 to Leong et al. entitled “Optical navigation sensor with integrated lens,” May 6, 2004.

U.S. Patent Publication No. 2005/0231482 to Theytaz et al. entitled “One-Chip USB Optical Mouse Sensor Solution,” Oct. 20, 2005.

The dates of the foregoing publications may correspond to any one of priority dates, filing dates, publication dates and issue dates. Listing of the above patents and patent applications in this background section is not, and shall not be construed as, an admission by the applicants or their counsel that one or more publications from the above list constitutes prior art in respect of the applicant's various inventions. All printed publications and patents referenced herein are hereby incorporated by referenced herein, each in its respective entirety.

Upon having read and understood the Summary, Detailed Description and Claims set forth below, those skilled in the art will appreciate that at least some of the systems, devices, components and methods disclosed in the printed publications listed herein may be modified advantageously in accordance with the teachings of the various embodiments of the present invention.

### SUMMARY

In a first embodiment of the present invention, there is provided an optical mouse illumination system for use on a substantially flat surface, the system comprising a light source configured to emit a first beam of light, at least one collimating lens configured to direct the first light beam in substantially a first direction towards an input face of an illumination prism, the illumination prism comprising a total internal reflection (TIR) mirror and an output face, the prism being configured to receive the first light beam through the input face and direct the first light beam towards the TIR mirror at an angle equaling or exceeding a critical angle, the prism further being configured to reflect the first light beam from the TIR mirror to form a second light beam that exits the output face of the prism in substantially a second direction at an angle of incidence that is near-normal in respect of the imaging surface, at least one imaging lens operably configured in respect of the prism to receive and direct a third light beam formed by the second light beam reflecting from the surface, and a sensor, wherein the third light beam is directed towards the sensor by the imaging lens.

In a second embodiment of the present invention, there is provided an optical mouse illumination system for use on a substantially fiat surface, the system comprising a light source configured to emit a first beam of light, at least one collimating lens configured to direct the first light beam in substantially a first direction towards an input face of an illumination prism, the illumination prism comprising first and second total internal reflection (TIR) mirrors and an output face, the prism being configured to receive the first light beam through the input face and direct the first light beam towards the first TIR mirror at an first angle equaling or exceeding a first critical angle, the prism further being configured to reflect the first light beam from the first TIR mirror to form a second light beam traveling in substantially a second direction towards the second TIR mirror at a second angle equaling or exceeding a second critical angle, the prism further being configured to reflect the second light beam from the second TIR mirror to form a third light beam that exits the output face of the prism in substantially a third direction at an angle of incidence that is near-normal in respect of the imaging surface, at least one imaging lens operably configured in respect of the prism to receive and direct a fourth light beam formed by the third light beam reflecting from the surface, and a sensor, wherein the fourth light beam is directed towards the sensor by the imaging lens.

In a third embodiment of the present invention, there is provided an optical mouse illumination system for use on a substantially flat surface, the system comprising a light source configured to emit a first beam of light, at least one collimating lens configured to direct the first light beam in substantially a first direction towards an input face of an illumination prism comprising a refracting output face, the prism being configured to receive the first light beam through the input face and direct the first light beam through the refracting output face as a second light beam traveling in substantially a second direction at an angle of incidence that is near-normal in respect of the imaging surface, at least one imaging lens operably configured in respect of the prism to receive and direct a third light beam formed by the second light beam reflecting from the surface, and a sensor, wherein the third light beam is directed towards the sensor by the imaging lens.

In a fourth embodiment of the present invention, there is provided a method of illuminating a surface using an optical mouse comprising a light source configured to emit a first beam of light, at least one collimating lens configured to direct the first light beam in substantially a first direction towards an input face of an illumination prism, the illumination prism comprising a total internal reflection (TIR) mirror and an output face, the prism being configured to receive the first light beam through the input face and direct the first light beam towards the TIR mirror at an angle equaling or exceeding a critical angle, the prism further being configured to reflect the first light beam from the TIR mirror to form a second light beam that exits the output face of the prism in substantially a second direction at an angle of incidence that is near-normal in respect of the imaging surface, at least one imaging lens operably configured in respect of the prism to receive and direct a third light beam formed by the second light beam reflecting from the surface, and a sensor, the third light beam being directed towards the sensor by the imaging lens, the method comprising actuating the light source, causing light to propagate through the prism and reflect from the surface, and sensing the light reflected from the surface with the sensor.

In a fifth embodiment of the present invention, there is provided a method of illuminating a surface using an optical mouse comprising a light source configured to emit a first beam of light, at least one collimating lens configured to direct the first light beam in substantially a first direction towards an input face of an illumination prism comprising a refracting output face, the prism being configured to receive the first light beam through the input face and direct the first light beam through the refracting output face as a second light beam traveling in substantially a second direction at an angle of incidence that is near-normal in respect of the imaging surface, at least one imaging lens operably configured in respect of the prism to receive and direct a third light beam formed by the second light beam reflecting from the surface, and a sensor, the third light beam being directed towards the sensor by the imaging lens, the method comprising actuating the light source, causing light to propagate through the prism and reflect from the surface, and sensing the light reflected from the surface with the sensor.

In a sixth embodiment of the present invention, there is provided a method of illuminating a surface using an optical mouse comprising a light source configured to emit a first beam of light, at least one collimating lens configured to direct the first light beam in substantially a first direction towards an input face of an illumination prism comprising a refracting output face, the prism being configured to receive the first light beam through the input face and direct the first light beam through the refracting output face as a second light beam traveling in substantially a second direction at an angle of incidence that is near-normal in respect of the imaging surface, at least one imaging lens operably configured in respect of the prism to receive and direct a third light beam formed by the second light beam reflecting from the surface, and a sensor, wherein the third light beam is directed towards the sensor by the imaging lens, the method comprising actuating the light source, causing light to propagate through the prism and reflect from the surface, and sensing the light reflected from the surface with the sensor.

In a seventh embodiment of the present invention, there is provided a method of making an optical mouse comprising a light source configured to emit a first beam of light, at least one collimating lens configured to direct the first light beam in substantially a first direction towards an input face of an illumination prism, the illumination prism comprising a total internal reflection (TIR) mirror and an output face, the prism being configured to receive the first light beam through the input face and direct the first light beam towards the TIR mirror at an angle equaling or exceeding a critical angle, the prism further being configured to reflect the first light beam from the TIR mirror to form a second light beam that exits the output face of the prism in substantially a second direction at an angle of incidence that is near-normal in respect of the imaging surface, at least one imaging lens operably configured in respect of the prism to receive and direct a third light beam formed by the second light beam reflecting from the surface, and a sensor, the third light beam being directed towards the sensor by the imaging lens, the method comprising providing the light source, the collimating lens, the illumination prism, the imaging lens and the sensor, and operatively configuring the light source, the collimating lens, the illumination prism, the imaging lens and the sensor in respect of one another to provide a working optical mouse illumination system.

### BRIEF DESCRIPTION OF THE DRAWINGS

Numerous aspects of the various embodiments of the present invention will become apparent from the following specification, drawings and claims in which;

FIG. 1 shows a prior art near-grazing incidence optical illumination system;

FIG. 2 shows a prior art beam-splitting optical illumination system;

FIG. 3 shows a prior art horizontal optical illumination system comprising an illumination prism and a total internal reflection mirror;

FIG. 4 shows a prior art vertical optical illumination system comprising an illumination prism and a total internal reflection mirror;

FIG. 5 shows one embodiment of a horizontal optical illumination system of the present invention comprising an illumination prism and a total internal reflection mirror;

FIG. 6 shows another embodiment of a vertical optical illumination system of the present invention comprising an illumination prism and no total internal reflection mirror, and

FIG. 7 shows yet another embodiment of a horizontal optical illumination system of the present invention comprising a multi-faceted collimating lens, an illumination prism and a total internal reflection mirror.

The drawings are not necessarily to scale. Like numbers refer to like parts or steps throughout the drawings.

### DETAILED DESCRIPTIONS OF SOME PREFERRED EMBODIMENTS

Set forth hereinbelow are detailed descriptions of some preferred embodiments of the present invention.

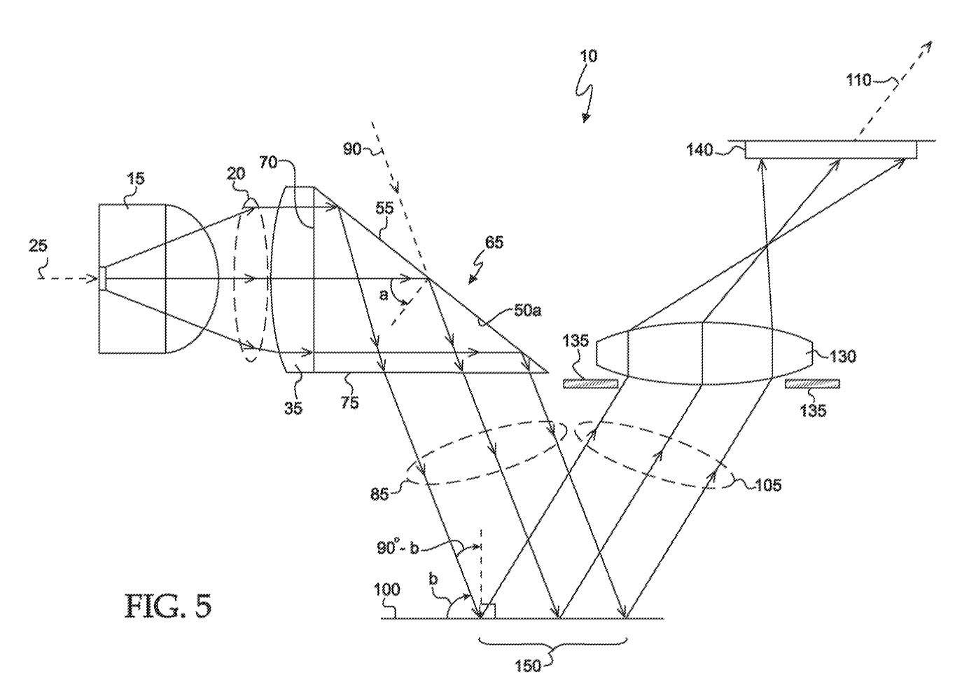

FIG. 5 shows one embodiment of a horizontal optical illumination system 10 of the present invention configured to project light beams from light source 15 onto imaging surface 100 at near-normal angles of incidence. By near-normal incidence, I mean angles of incidence b by second or third light beams 85 or 105 respecting a normal to surface 100 that range between about 3 degrees and about 30 degrees. By near-normal incidence I also mean angles of incidence (90°-b) ranging between about 60 degrees and about 87 degrees respecting surface 100. In accordance with the various embodiments of the present invention, angle b is kept as small as possible such that second or third light beams 85 or 105 hit surface 100 and are reflected therefrom as close to normal as possible. A limiting factor in such a configuration is the spacing between prism 65 and imaging lens 130, which must be separated by some distance to avoid interference. Given the physical constraints imposed upon the design and construction of system 10, typical values for angle b range between about 10 degrees and about 25 degrees, with values of between about 15 degrees and about 20 degrees being most typical.

In the various embodiments of the present invention, light source 15 is most preferably an LED, and more preferably yet an LED that emits light in the near-infrared or red wave bands (e.g., between about 620 nm and about 780 nm). Other LEDs may of course be used, such as orange, yellow, white, green or blue LEDs that emit light at shorter wavelengths or higher color temperatures (e.g., around 605 nm, 585 nm, 6500K to 8000K, 560 nm, and 470 nm, respectively). In referring to the wave bands of the foregoing LED colors, I mean wavelengths centered approximately about the foregoing values and having wavelengths that depart approximately 5% to either side of the foregoing center wavelengths. Light sources other than LEDs may also be employed in system 10 of the present invention, such as lasers, vertical cavity surface emitting lasers (VCSELs), incandescent light sources, and other suitable types of coherent and incoherent light sources. Note that light source 15 of the present invention may further be configured to emit light in conjunction with a reflector, retro-reflector and/or a highly reflective surface, where such reflective elements are disposed about or near light source 15 to direct light more efficiently in first direction 25.

Continuing to refer to FIG. 5, system 10 comprises illumination prism 65 and total internal reflection mirror 55. LED 15 emits a first direct beam of light 20 in a first direction 25. Collimating lens 35 gathers first light beam 20 and directs same through input face 70 of illumination prism 65 for reflection from first reflecting face 50a of total internal reflection (“TIR”) mirror 55 to form second light beam 85 travelling in second direction 90. As shown in FIG. 5, first reflecting face 50a comprises TIR mirror 55. Second beam 85 is refracted by refracting output face 75 of prism 65, and is incident on surface 100. Second beam 85 is reflected from surface 100 to form third beam 105, which travels upwardly in direction 110 for collimation by imaging lens 130 (not shown). Note that Aperture stop 135 may be placed in front of imaging lens 130, or behind imaging lens 130.

As illustrated in FIG. 5, and in various other embodiments of the present invention, object area 150 is advantageously relatively uniformly illuminated over a small area ranging between about 1 mm and about 3 mm in length (i.e., along the page) and between about 1 mm and about 2 mm in width (i.e., into the page), or between about 1 mm² and about 6 mm² in surface area.

Illumination prism 65 is configured in respect of light source 15, collimating lens 35 and first light beam 20 such that beam 20 hits first reflecting face 50a at an angle greater than or equal to the critical angle, which is determined by the refractive index of the material from which prism 65 is formed, and the refractive index of the medium surrounding prism 65 (e.g., air). The critical angle is the minimum angle of incidence at which total internal reflection (TIR) occurs. The angle of incidence b in FIG. 5 is measured with respect to the normal to the refractive boundary. The critical angle θ_{c} is given by:

$${θ}_{c} = arcsin ( \frac{{n}_{2}}{{n}_{1}} ) ,$$

where n₂ is the refractive index of the less dense medium (e.g., air), and n₁ is the refractive index of the denser medium (i.e., prism 65). This equation is a simple application of Snell's Law where the angle of refraction is 90°. Because first beam 20 light is totally internally reflected from TIR 55/first reflecting face 50a, virtually no energy is lost by transmission through face 50a.

In the case where prism 65 is formed or molded from polycarbonate (a preferred material from which to form or mold prism 65), the critical angle is about 39 degrees. In the case where prism 65 is formed from glass, plastic, acrylic or another material, the critical angle will likely be different owing to the refractive indices of such materials being different from that of polycarbonate. One advantage of TIR mirror 55 in prism 65 is that no coating is required on the external surface thereof to enhance the degree or amount of reflection therefrom, although TIR mirror 55 may also be coated with a highly reflective coating to further improve reflective optical efficiency.

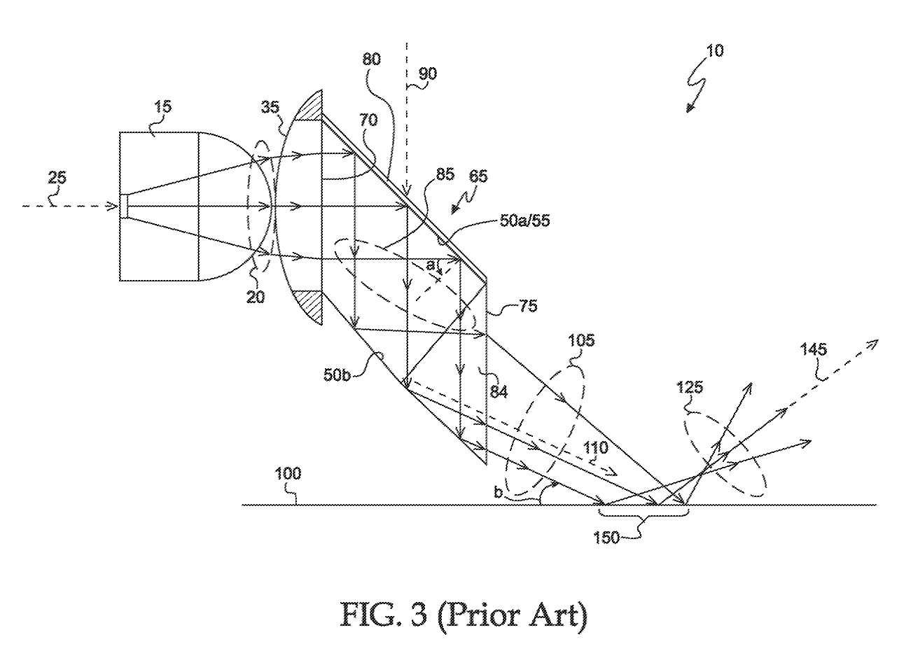

In the various embodiments of the present invention, TIR 55 may include a roof prism, a faceted roof prism, a four-faced faceted prism, a folded roof prism, a vertical roof prism, a horizontal roof prism, a vertically-folded prism, a horizontally-folded prism, a pyramidal prism or any other suitable type of prism. For example, TIR 55 of FIG. 5 may include a folded roof prism 80 of the type shown in FIG. 3, where folded roof prism 80 assumes a roughly triangular shape in cross-section and has two facets or principal surfaces. Other types of roof prisms may also be employed in conjunction with TIR mirror 55, such as a pyramidal roof prism having four faceted faces. Prisms employed in conjunction with TIR 55 are preferably designed and configured to eliminate or reduce the effects of holes or dark spots appearing in light beam 20 resulting from the manner in which LED 15 is bonded to its underlying die. This problem, and various solutions thereto employing prisms having different configurations, is discussed in detail in U.S. Pat. No. 6,478,970 to Smith entitled “Illumination Optics and Methods” and in U.S. Pat. No. 6,829,098 to Smith entitled “Illumination Optics and Methods.”

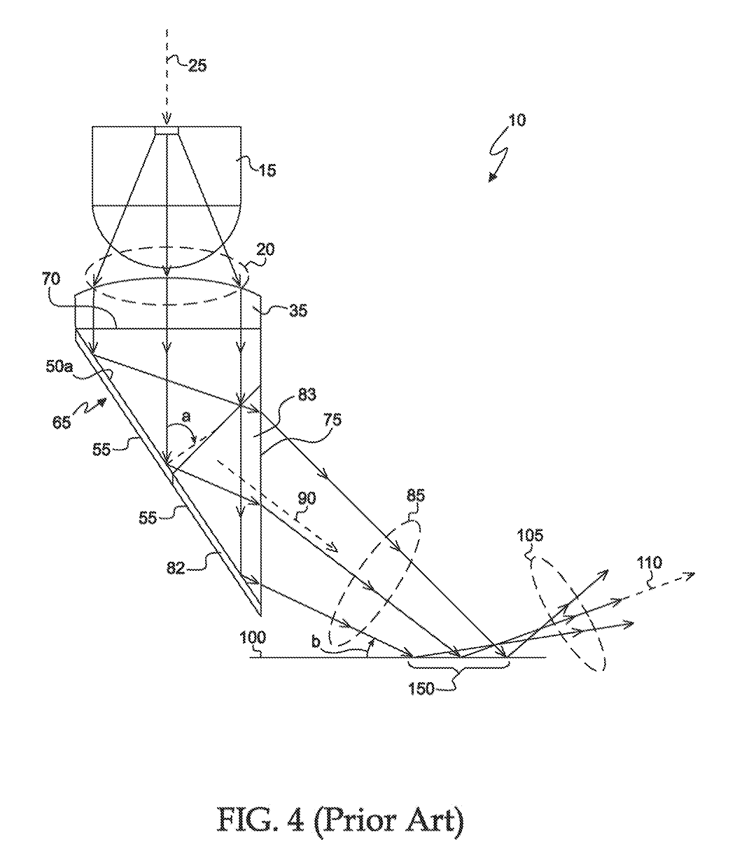

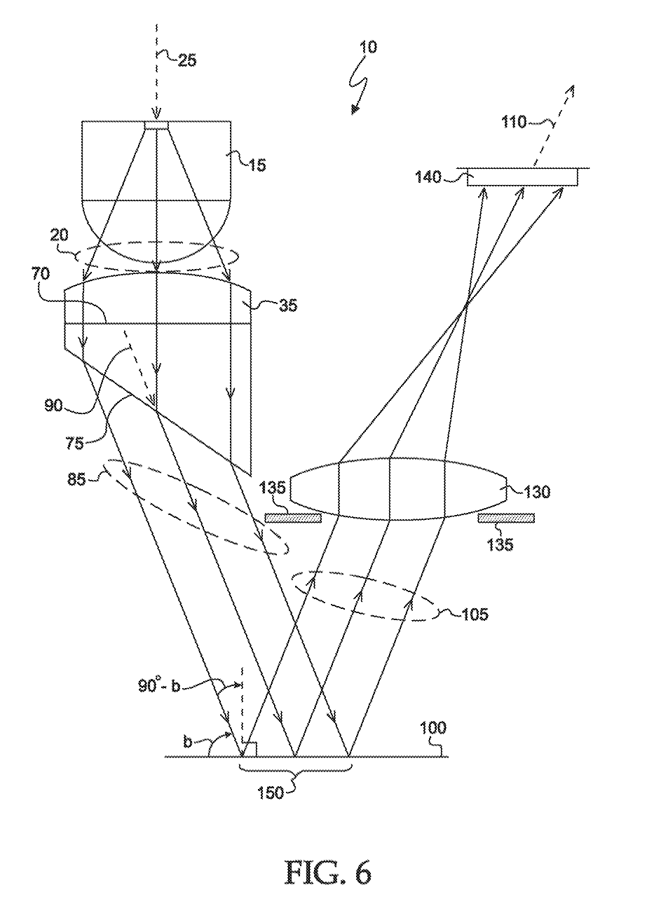

FIG. 6 shows a vertical optical illumination system 10 of the present invention comprising illumination prism 65. Unlike systems 10 shown in FIGS. 3 through 5, system 10 in FIG. 6 features no total internal reflection mirror 55. LED 15 emits a first direct beam of incoherent light 20 in first direction 25. Collimating lens 35 gathers first light beam 20 and directs same through input face 70 of illumination prism 65 for direction therethrough. As shown in FIG. 6, second beam 85 travelling in direction 90 is refracted by refracting output face 75 of prism 65, and then becomes incident on surface 100. Second beam 85 is reflected from surface 100 to form third beam 105, which travels upwardly in direction 110 for collimation by imaging lens 130, and direction to sensor 140. As illustrated in FIG. 6, object area 150 is advantageously relatively uniformly illuminated over a small area.

In system 10 illustrated in FIG. 6, and in other embodiments of the present invention, illumination object area 150 preferably comprises a surface area ranging between about 1 mm and about 3 mm in length (i.e., along the page) and between about 1 mm and about 2 mm in width (i.e., into the page), or between about 1 mm² and about 6 mm² in surface area.

It will be noted that no reflections at angles that are critical or greater than critical occur in prism 65 of the embodiment of the present invention illustrated in FIG. 6, nor are any TIR mirrors employed therein. Instead first and second beams 20 and 85 are directed through or emerge from prism 65 without such reflections having occurred. Note, however, that refracting output face 75 may comprise a roof, pyramid or other type of suitable prism such as those described hereinabove, and such prism may further be configured to eliminate or reduce the effects of the aforementioned holes or spots in light beam 20.

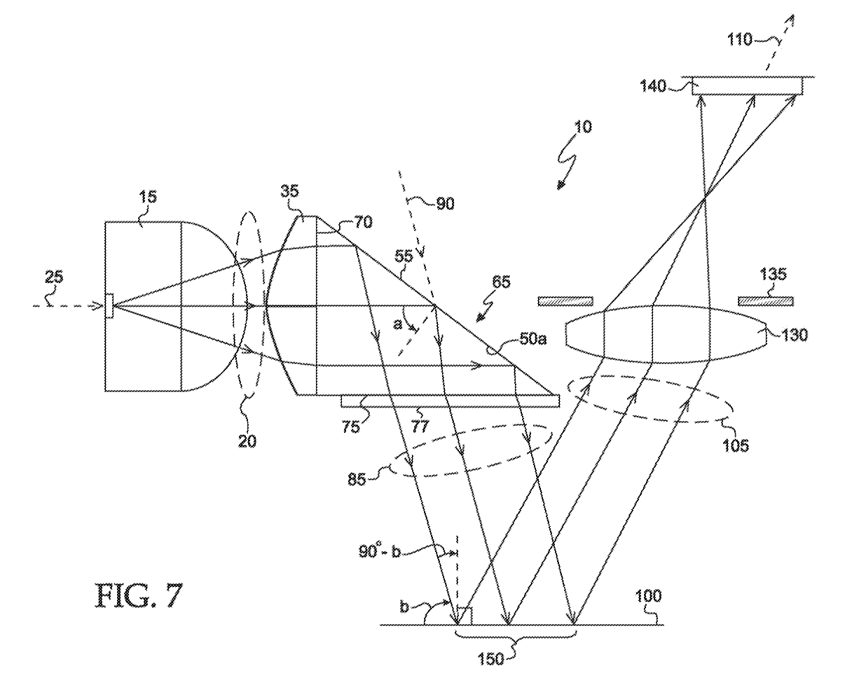

FIG. 7 shows yet another embodiment of a horizontal optical illumination system 10 of the present invention comprising multi-faceted collimating lens 35, illumination prism 65 and total internal reflection mirror 55. As shown in FIG. 7, multi-faceted collimating lens 35 assumes the form of a pyramidally-shaped lens having four faces having an apex coincident with the optical axis of lens 35. LED 15 emits a first direct beam of light 20 in first direction 25. Multi-faceted collimating lens 35 gathers first light beam 20 and directs same through input face 70 of illumination prism 65 for reflection from reflecting face 50a of total internal reflection (“TIR”) mirror 55 to form second light beam 85 travelling in second direction 90. As shown in FIG. 7, first reflecting face 50a comprises TIR mirror 55. Second beam 85 is refracted by refracting output element 77 of prism 65, and then becomes incident on surface 100. Second beam 85 is reflected from surface 100 to form third beam 105, which travels upwardly in direction 110 for collimation by imaging lens 130 (not shown). As illustrated in FIG. 7, object area 150 is advantageously relatively uniformly illuminated over a small area in manner similar that described above respecting FIGS. 5 and 6.

Continuing to refer to FIG. 7, illumination prism 65 is configured in respect of light source 15, collimating lens 35 and first light beam 20 such that beam 20 hits first reflecting face 50a at an angle greater than or equal to the critical angle. TIR 55 may include a four-faceted-face roof prism, a vertically-folded prism, a roof prism or any other suitable type of prism that is most preferably designed and configured to eliminate or reduce the effects of holes or dark spots appearing in light beam 20 as discussed hereinabove.

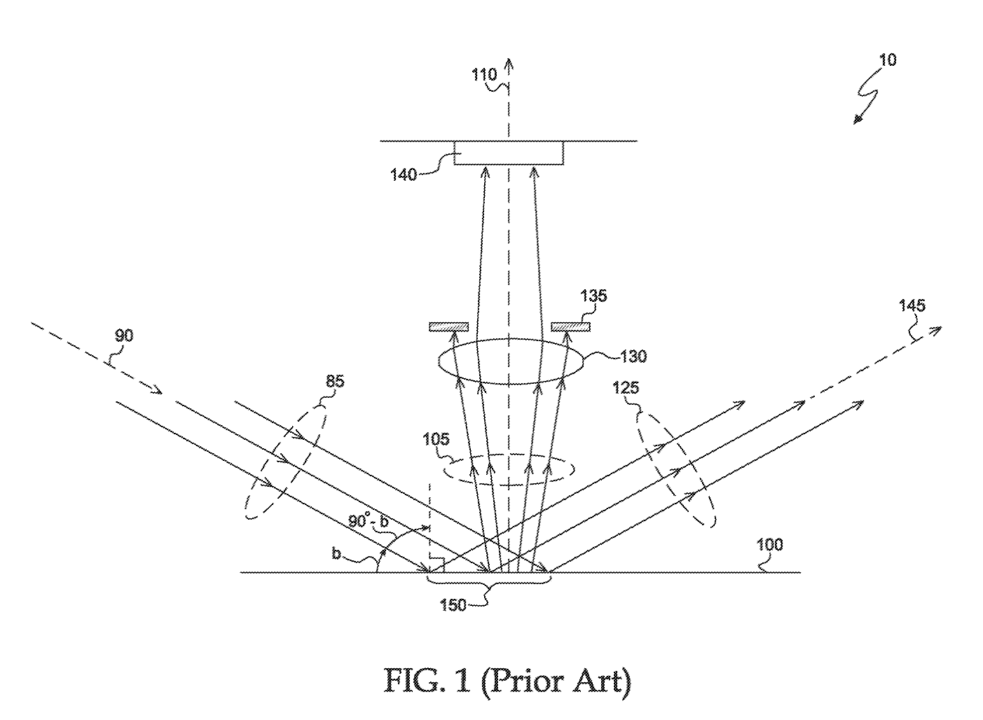

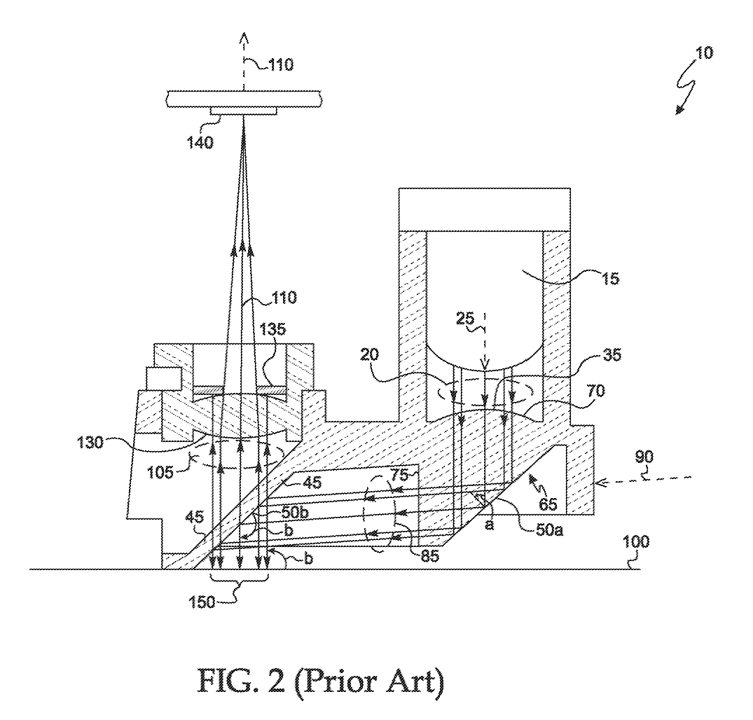

Systems 10 in FIGS. 5 through 7 provide near-normal incidence of light beams in respect of surface 100, and therefore have longer focal lengths, and provide improved scattering of light, in respect of system 10 illustrated in FIG. 1. Unlike beam-splitting illumination system 10 shown in FIG. 2, no beam-splitting mirrors are employed in systems 10 of FIGS. 5 through 7, and yet near-normal incidence of light beams upon surface 100 is achieved without the use of difficult-to-manufacture elaborate or complicated optical systems. Consequently, light beams 85 or 105 in systems 10 of FIGS. 5 through 7 do not undergo multiple reflections between beam splitting mirror 45 and surface 100. Systems 10 illustrated in FIGS. 5 through 7 therefore have fewer losses than do systems 10 shown in FIGS. 1 through 4. Indeed, the efficiencies of systems 10 in FIGS. 5 through 7 theoretically exceed 90%, and in actual practice may exceed 80%. Consequently, systems 10 in FIGS. 5 through 7 consume much less power than systems 10 shown in FIGS. 1 through 4, making them highly suitable for battery-powered mouse applications. Additionally, the relatively simple shapes, inexpensive components, and simplified configurations of systems 10 in FIGS. 5 through 7 provide systems 10 that are relatively easy to manufacture, mechanically robust and reliable, and have a smaller footprint or size in respect of systems 10 illustrated in FIGS. 1 through 4.

Collimation lens 35 or imaging lens 130 may be selected from the group consisting of a multi-faceted lens, a concave lens, a plano-concave lens, a bi-concave lens, a convex lens, a plano-convex lens, a bi-concave lens, a convex-concave lens, a lens having at least one aspherical surface, a lens having opposing aspherical surfaces, a positive meniscus lens, and a negative meniscus lens.

Sensor 140 is most preferably a CMOS or CCD light sensor formed form a single integrated circuit or chip, and having a suitably large array of photosensors disposed on the receiving surface thereof. Sensor 140 may also be an Application Specific Integrated Circuit (ASIC) optimized for use in an optical illumination system of the present invention.

It will be understood by those skilled in the art that numerous variations, modifications, permutations and combinations of the foregoing optical mouse illumination systems may be employed with the benefit of the hindsight provided by the present disclosure, and that many of such variations, modifications, permutations and combinations will fail within the scope of the present invention. The present invention includes within its scope methods of making and using the systems, devices and components described herein.

The preceding specific embodiments are illustrative of the practice of the invention. It is to be understood, therefore, that other expedients known to those skilled in the art or disclosed herein may be employed without departing from the invention or the scope of the appended claims. For example, some embodiments of the present invention are not limited to optical mouse illumination systems that employ critical angle reflection. Having read and understood the present disclosure, those skilled in the art will now understand that many combinations, adaptations, variations and permutations of known optical mouse illumination systems may be employed successfully in the present invention.

In the claims, means plus function clauses are intended to cover the structures described herein as performing the recited function and their equivalents. Means plus function clauses in the claims are not intended to be limited to structural equivalents only, but are also intended to include structures which function equivalently in the environment of the claimed combination.

All printed publications and patents referenced hereinabove are hereby incorporated by referenced herein, each in its respective entirety. The present invention includes within its scope methods of making and using the systems, devices and components described hereinabove.

I claim:

1. An near-normal incidence optical mouse illumination system for use on a substantially flat imaging surface, the system comprising a light source configured to emit a first beam of light, at least one collimating lens configured to direct the first light beam in substantially a first direction towards an input face of an illumination prism, the illumination prism comprising a total internal reflection (TIR) mirror and an output face, the prism being configured to receive the first light beam through the input face and direct the first light beam towards the TIR mirror at an angle equaling or exceeding a critical angle, the prism further being configured to reflect the first light beam from the TIR mirror to form a second light beam that exits the output face of the prism in substantially a second direction that is near-normal in respect of the imaging surface, at least one imaging lens operably configured in respect of the prism to receive and direct a third light beam formed by the second light beam reflecting from the surface, and a sensor, wherein the third light beam is directed towards the sensor by the imaging lens.

2. The optical mouse illumination system of claim 1, wherein the system is configured as one of a horizontal optical mouse illumination system and a vertical optical mouse illumination system.

3. The optical mouse illumination system of claim 1, wherein the TIR mirror further comprises a roof prism selected from the group consisting of a pyramidal roof prism, a folded roof prism, a horizontal roof prism and a vertical roof prism.

4. The optical mouse illumination system of claim 1, wherein the output face of the illumination prism is incorporated into a roof prism forming a portion of the illumination prism.

5. The optical mouse illumination system of claim 1, wherein the output face of the illumination prism is a refracting face.

6. The optical mouse illumination system of claim 1, wherein the sensor is selected from the group consisting of a CMOS light sensor, a CCD, an integrated circuit, a chip and an ASIC.

7. The optical mouse illumination system of claim 1, wherein the light source is a light emitting diode (LED) selected from the group consisting of an LED configured to emit light in the near-infrared wave band, an LED configured to emit light in the red wave band, an LED configured to emit light in the orange wave band, an LED configured to emit light in the yellow wave band, an LED configured to emit light in the white wave band, an LED configured to emit light in green wave band, and an LED configured to emit light in the blue wave band.

8. The optical mouse illumination system of claim 1, wherein the light source is selected from the group consisting of a laser, a VCSEL, an incandescent light source, a coherent light source, and an incoherent light source.

9. The optical mouse illumination system of claim 1, wherein the illumination prism is molded from at least one of polycarbonate, glass, acrylic and a polymeric substance.

10. The optical mouse illumination system of claim 1, wherein the system is configured to direct the second beam at the surface at an incident angle selected from the group consisting between about 3 degrees and about 30 degrees in respect of a normal to the imaging surface, between about 5 degrees and about 25 degrees in respect of a normal to the imaging surface, and between about 10 degrees and about 20 degrees in respect of a normal to the imaging surface.

11. The optical mouse illumination system of claim 1, wherein the system is configured to project the second beam onto the surface over a confined object illumination area ranging between about 1 mm² and about 6 mm², the confined area being substantially uniformly illuminated by the second beam.

12. The optical mouse illumination system of claim 1, further comprising an aperture stop disposed adjacent the imaging lens.

13. The optical mouse illumination system of claim 1, wherein at least one of the collimation lens and the imaging lens is selected from the group consisting of a multi-faceted lens, a concave lens, a plano-concave lens, a bi-concave lens, a convex lens, a plano-convex lens, a bi-concave lens, a convex-concave lens, a lens having at least one aspherical surface, a lens having opposing aspherical surfaces, a positive meniscus lens, and a negative meniscus lens.

14. The optical mouse illumination system of claim 1, further comprising at least one of a reflector, a retro-reflector and a highly reflective surface disposed about or near the light source to direct light in the first direction.

15. The optical mouse illumination system of claim 1, wherein the collimation lens is attached to the input face of the illumination prism.

16. An optical mouse illumination system for use on a substantially flat surface, the system comprising a light source configured to emit a first beam of light, at least one collimating lens configured to direct the first light beam in substantially a first direction towards an input face of an illumination prism, the illumination prism comprising first and second total internal reflection (TIR) mirrors and an output face, the prism being configured to receive the first light beam through the input face and direct the first light beam towards the first TIR mirror at an first angle equaling or exceeding a first critical angle, the prism further being configured to reflect the first light beam from the first TIR mirror to form a second light beam traveling in substantially a second direction towards the second TIR mirror at a second angle equaling or exceeding a second critical angle, the prism further being configured to reflect the second light beam from the second TIR mirror to form a third light beam that exits the output face of the prism in substantially a third direction that is near-normal in respect of the imaging surface, at least one imaging lens operably configured in respect of the prism to receive and direct a fourth light beam formed by the third light beam reflecting from the surface, and a sensor, wherein the fourth light beam is directed towards the sensor by the imaging lens.

17. The optical mouse illumination system of claim 16, wherein the system is configured as one of a horizontal optical mouse illumination system and a vertical optical mouse illumination system.

18. The optical mouse illumination system of claim 16, wherein at least one of the first TIR mirror and the second TIR mirror further comprises a roof prism selected from the group consisting of a pyramidal roof prism, a folded roof prism, a horizontal roof prism and a vertical roof prism.

19. The optical mouse illumination system of claim 16, wherein the output face of the illumination prism is incorporated into a roof prism forming a portion of the illumination prism.

20. The optical mouse illumination system of claim 16, wherein the output face of the illumination prism is a refracting face.

21. The optical mouse illumination system of claim 16, wherein the illumination prism is molded from at least one of polycarbonate, glass, acrylic and a polymeric substance.

22. The optical mouse illumination system of claim 16, wherein the system is configured to direct the second beam at the surface at an incident angle selected from the group consisting between about 3 degrees and about 30 degrees in respect of a normal to the imaging surface, between about 5 degrees and about 25 degrees in respect of a normal to the imaging surface, and between about 10 degrees and about 20 degrees in respect of a normal to the imaging surface.

23. The optical mouse illumination system of claim 16, wherein the system is configured to project the second beam onto the surface over a confined object illumination area ranging between about 1 mm² and about 6 mm², the confined area being substantially uniformly illuminated by the second beam.

24. The optical mouse illumination system of claim 16, wherein at least one of the collimation lens and the imaging lens is selected from the group consisting of a multi-faceted lens, a concave lens, a plano-concave lens, a bi-concave lens, a convex lens, a plano-convex lens, a bi-concave lens, a convex-concave lens, a lens having at least one aspherical surface, a lens having opposing aspherical surfaces, a positive meniscus lens, and a negative meniscus lens.

25. The optical mouse illumination system of claim 16, wherein the collimation lens is attached to the input face of the illumination prism.

26. The optical mouse illumination system of claim 16, wherein the light source is a light emitting diode (LED) selected from the group consisting of an LED configured to emit light in the near-infrared wave band, an LED configured to emit light in the red wave band, an LED configured to emit light in the orange wave band, an LED configured to emit light in the yellow wave band, an LED configured to emit light in the white wave band, an LED configured to emit light in green wave band, and an LED configured to emit light in the blue wave band.

27. The optical mouse illumination system of claim 16, wherein the light source is selected from the group consisting of a laser, a VCSEL, an incandescent light source, a coherent light source, and an incoherent light source.

28. An optical mouse illumination system for use on a substantially flat surface, the system comprising a light source configured to emit a first beam of light, at least one collimating lens configured to direct the first light beam in substantially a first direction towards an input face of an illumination prism comprising a refracting output face, the prism being configured to receive the first light beam through the input face and direct the first light beam through the refracting output face as a second light beam traveling in substantially a second direction towards the surface that is near-normal in respect of the imaging surface, at least one imaging lens operably configured in respect of the prism to receive and direct a third light beam formed by the second light beam reflecting from the surface, and a sensor, wherein the third light beam is directed towards the sensor by the imaging lens.

29. The optical mouse illumination system of claim 28, wherein the system is configured as one of a horizontal optical mouse illumination system and a vertical optical mouse illumination system.

30. The optical mouse illumination system of claim 28, wherein the output face of the illumination prism is incorporated into a roof prism forming a portion of the illumination prism.

31. The optical mouse illumination system of claim 28, wherein the illumination prism is molded from at least one of polycarbonate, glass, acrylic and a polymeric substance.

32. The optical mouse illumination system of claim 28, wherein the system is configured to direct the second beam at the surface at an incident angle selected from the group consisting between about 3 degrees and about 30 degrees in respect of a normal to the imaging surface, between about 5 degrees and about 25 degrees in respect of a normal to the imaging surface, and between about 10 degrees and about 20 degrees in respect of a normal to the imaging surface.

33. The optical mouse illumination system of claim 28, wherein the system is configured to project the second beam onto the surface over a confined object illumination area ranging between about 1 mm² and about 6 mm², the confined area being substantially uniformly illuminated by the second beam.

34. The optical mouse illumination system of claim 28, wherein at least one of the collimation lens and the imaging lens is selected from the group consisting of a multi-faceted lens, a concave lens, a plano-concave lens, a bi-concave lens, a convex lens, a plano-convex lens, a bi-concave lens, a convex-concave lens, a lens having at least one aspherical surface, a lens having opposing aspherical surfaces, a positive meniscus lens, and a negative meniscus lens.

35. The optical mouse illumination system of claim 28, wherein the collimation lens is attached to the input face of the illumination prism.

36. The optical mouse illumination system of claim 28, wherein the light source is a light emitting diode (LED) selected from the group consisting of an LED configured to emit light in the near-infrared wave band, an LED configured to emit light in the red wave band, an LED configured to emit light in the orange wave band, an LED configured to emit light in the yellow wave band, an LED configured to emit light in the white wave band, an LED configured to emit light in green wave band, and an LED configured to emit light in the blue wave band.

37. The optical mouse illumination system of claim 28, wherein the light source is selected from the group consisting of a laser, a VCSEL, an incandescent light source, a coherent light source, and an incoherent light source.

38. A method of illuminating a surface using an optical mouse comprising a light source configured to emit a first beam of light, at least one collimating lens configured to direct the first light beam in substantially a first direction towards an input face of an illumination prism, the illumination prism comprising a total internal reflection (TIR) mirror and an output face, the prism being configured to receive the first light beam through the input face and direct the first light beam towards the TIR mirror at an angle equaling or exceeding a critical angle, the prism further being configured to reflect the first light beam from the TIR mirror to form a second light beam that exits the output face of the prism in substantially a second direction that is near-normal in respect of the imaging surface, at least one imaging lens operably configured in respect of the prism to receive and direct a third light beam formed by the second light beam reflecting from the surface, and a sensor, the third light beam being directed towards the sensor by the imaging lens, the method comprising actuating the light source, causing light to propagate through the prism and reflect from the imaging surface at a near-normal angle, and sensing the light reflected from the surface with the sensor.

39. A method of illuminating a surface using an optical mouse comprising a light source configured to emit a first beam of light, at least one collimating lens configured to direct the first light beam in substantially a first direction towards an input face of an illumination prism comprising a refracting output face, the prism being configured to receive the first light beam through the input face and direct the first light beam through the refracting output face as a second light beam traveling in substantially a second direction at a near-normal angle of incidence in respect of the imaging surface, at least one imaging lens operably configured in respect of the prism to receive and direct a third light beam formed by the second light beam reflecting from the surface, and a sensor, the third light beam being directed towards the sensor by the imaging lens, the method comprising actuating the light source, causing light to propagate through the prism and reflect from the surface, and sensing the light reflected from the surface with the sensor.

40. A method of illuminating a surface using an optical mouse comprising a light source configured to emit a first beam of light, at least one collimating lens configured to direct the first light beam in substantially a first direction towards an input face of an illumination prism comprising a refracting output face, the prism being configured to receive the first light beam through the input face and direct the first light beam through the refracting output face as a second light beam traveling in substantially a second direction at a near-normal angle of incidence in respect of the imaging surface, at least one imaging lens operably configured in respect of the prism to receive and direct a third light beam formed by the second light beam reflecting from the surface, and a sensor, wherein the third light beam is directed towards the sensor by the imaging lens, the method comprising actuating the light source, causing light to propagate through the prism and reflect from the surface, and sensing the light reflected from the surface with the sensor.

41. A method of making an optical mouse comprising a light source configured to emit a first beam of light, at least one collimating lens configured to direct the first light beam in substantially a first direction towards an input face of an illumination prism, the illumination prism comprising a total internal reflection (TIR) mirror and an output face, the prism being configured to receive the first light beam through the input face and direct the first light beam towards the TIR mirror at an angle equaling or exceeding a critical angle, the prism further being configured to reflect the first light beam from the TIR mirror to form a second light beam that exits the output face of the prism in substantially a second direction at a near-normal angle of incidence in respect of the imaging surface, at least one imaging lens operably configured in respect of the prism to receive and direct a third light beam formed by the second light beam reflecting from the surface, and a sensor, the third light beam being directed towards the sensor by the imaging lens, the method comprising providing the light source, the collimating lens, the illumination prism, the imaging lens and the sensor, and operatively configuring the light source, the collimating lens, the illumination prism, the imaging lens and the sensor in respect of one another to provide a working optical mouse illumination system.
